(19) United States
(12) Patent Application Publication
(10) Pub. No.: US 2025/0336312 A1
(43) Pub. Date: Oct. 30, 2025

(54) ENDOBRONCHIAL TOOL TRAINING DEVICE AND ASSOCIATED METHODS

(71) Applicant: INTUITIVE SURGICAL OPERATIONS, INC., Sunnyvale, CA (US)

(72) Inventors: Richard H. FEINS, Grantham, NH (US); Jay ROHDE, Chapel Hill, NC (US)

(73) Assignee: INTUITIVE SURGICAL OPERATIONS, INC., Sunnyvale, CA (US)

(21) Appl. No.: 19/183,973

(22) Filed: Apr. 21, 2025

Related U.S. Application Data
(60) Provisional application No. 63/637,905, filed on Apr. 24, 2024.

(51) Int. Cl. G09B 23/32

(52) U.S. Cl. CPC G09B 23/32

(57) ABSTRACT

An endobronchial tool training device may include a simulated human lung main airway network, and at least one training cartridge removably coupled to the simulated human lung main airway network. The training cartridge may include a body of simulated lung tissue having at least one simulated abnormality, and a simulated human lung branch airway network. An endobronchial tool is steerable through the simulated human lung main airway network and into the simulated human lung branch airway network to a position adjacent at least one simulated abnormality.

### PRIORITY APPLICATION(S)

This application is based upon U.S. provisional Application No. 63/637,905, filed Apr. 24, 2024, the disclosure which is hereby incorporated by reference in its entirety.

### FIELD OF THE INVENTION

The present invention is directed to surgical training, and more particularly, to an endobronchial tool training device having a simulated human lung main airway network and related methods.

### BACKGROUND OF THE INVENTION

Surgical procedures may be performed using open or general surgery, laparoscopic surgery, and/or robotically assisted surgery. To become qualified to perform surgical procedures, surgeons participate in comprehensive training to become proficient in the variety of tasks required to perform the procedures. Such tasks include inserting and directing surgical tools to anatomical features of interest such as tissue or organs, manipulating tissue, grasping, clamping, cutting, sealing, suturing, and stapling tissue, as well as other tasks. To gain proficiency, it is beneficial to allow surgeons to repeatedly practice these tasks for multiple different procedures. In addition, it can be beneficial to quantify training and performance of such tasks by surgeons, thereby enabling them to track progress and improve performance.

Various surgical training systems have been developed to provide surgical training. For example, training may be conducted on human cadavers. However, cadavers may be expensive and provide limited opportunities to train. In addition, a single cadaver may not allow the surgeon to repeatedly practice the same procedure. Surgical tissue models have also been utilized for surgical training. However, these tissue models may not be suitable for training minimally invasive procedures using laparoscopic or robotically assisted tools. In minimally invasive procedures, the surgical tools must be inserted into the body via natural orifices or small surgical incisions and then positioned near the anatomical features of interest.

Harvested porcine tissue has been used to develop surgical training models for use in thoracic and cardiac surgery because the anatomy of the porcine organs, such as the heart and lungs, are similar in anatomy to human organs. Use of harvested porcine tissue or other harvested animal tissue, however, is challenging when used with a robotic-assisted bronchoscopy system, such as the ION robotic-assisted minimally invasive biopsy platform from Intuitive Surgical Operations, Inc.

This robotic-assisted bronchoscopy system allows for endoscopic diagnosis and potentially treatment of lung tumors. However, training bronchoscopists on how to use this system may require a model of the lung with identifiable airways and one or more tumors. Current training techniques involve the use of porcine lung with artificial tumors placed into the parenchyma. This training model presents several challenges. The porcine lung differs from the human lung and has a different airway configuration and lobar anatomy. After placement of the artificial tumors, the lung is inflated and deflated several times. During these inflations, the lungs ideally should look identical on a CT scan so that the pathway for a given tumor as constructed initially will still be valid. Because the lung tissue compliance changes over time, it is difficult to duplicate the degree of lung expansion during the training, which results in the pathway that was originally planned being divergent from the subsequent airway. Placement of the tumors is also arbitrary, making use of a standardized curriculum for training difficult. Lung tissue hydration also changes with time causing the tumors to change in size and configuration from what was present on the planning CT scan. This negatively impacts the training.

### SUMMARY OF THE INVENTION

This summary is provided to introduce a selection of concepts that are further described below in the Detailed Description. This summary is not intended to identify key or essential features of the claimed subject matter, nor is it intended to be used as an aid in limiting the scope of the claimed subject matter.

An endobronchial tool training device may comprise a simulated human lung main airway network, and at least one training cartridge removably coupled to the simulated human lung main airway network. The at least one training cartridge may comprise a body of simulated lung tissue, at least one simulated abnormality within the body of simulated lung tissue, and a simulated human lung branch airway network within the body of simulated lung tissue and coupled with the simulated human lung main airway network so that an endobronchial tool is steerable through the simulated human lung main airway network and into the simulated human lung branch airway network to a position adjacent the at least one simulated abnormality.

The simulated human lung main airway network may have a proximal opening to receive the endobronchial tool therein and at least one distal opening coupled to the at least one training cartridge. The simulated human lung branch airway network may comprise interconnected branches, and the at least one simulated abnormality may be between adjacent branches. The simulated human lung main airway network and at least one training cartridge may each comprise respective materials compatible with medical imaging so that the at least one simulated abnormality is visible. The at least one training cartridge may comprise a housing surrounding the body of simulated lung tissue. The housing and adjacent portions of the simulated human lung main airway network may define a plurality of selectable rotational coupling angles therebetween. The plurality of selectable rotational coupling angles may define respective different abnormality positions.

The at least one simulated abnormality may comprise at least one simulated tumor. The at least one simulated tumor may comprise a hydrogel. The at least one simulated tumor may comprise at least one preformed simulated tumor injected into the body of simulated lung tissue. The at least one simulated tumor may comprise at least one preformed simulated tumor molded into the body of simulated lung tissue. The at least one simulated tumor may comprise at least one three-dimensional printed simulated tumor formed concurrently with the body of simulated lung tissue.

The at least one training cartridge may comprise a temperature sensitive element associated therewith. The temperature sensitive element may be positioned within the body of simulated lung tissue. The temperature sensitive element may comprise a temperature sensor. The temperature sensitive element may comprise a thermochromic material. The body of simulated lung tissue may comprise hydrogel. The simulated human lung main airway network may comprise a plurality of interconnected tubes. The simulated human lung main airway network may have a proximal opening for receiving a respiration simulator for delivering air to the simulated human lung main airway network and the simulated human lung branch airway network.

The endobronchial tool training device may further comprise a simulated human lung main blood vessel network. The at least one training cartridge may further comprise a simulated human lung branch blood vessel network. The simulated human lung main blood vessel network may have a proximal opening for receiving a perfusion simulator for delivering simulated blood to the simulated human lung main blood vessel network and the simulated human lung branch blood vessel network.

The at least one training cartridge may comprise a plurality of different training cartridges for respective different training scenarios. Each of the plurality of different training cartridges may have a different simulated abnormality. The different simulated abnormality may comprise at least one of a different tumor type, size, shape and location. Each of the plurality of different training cartridges may have a different simulated human lung branch airway network. The at least one training cartridge may comprise a plurality of training cartridges coupled to the simulated human lung main airway network at different respective locations. The at least one training cartridge may comprise a plurality of training cartridges coupled to the simulated human lung main airway network with different respective rotational orientations. The at least one training cartridge may comprise a material being at least one of imaging-abled, self-healing, ablation-responsive, and electrocautery-responsive.

Another aspect is directed to a method for making an endobronchial tool training device. The method may comprise removably coupling at least one training cartridge to a simulated human lung main airway network. The at least one training cartridge may comprise a body of simulated lung tissue, at least one simulated abnormality within the body of simulated lung tissue, and a simulated human lung branch airway network within the body of simulated lung tissue and coupled with the simulated human lung main airway network so that an endobronchial tool is steerable through the simulated human lung main airway network and into the simulated human lung branch airway network to a position adjacent the at least one simulated abnormality.

Another aspect is directed to a method for making a training cartridge to be removably coupled to a simulated human lung main airway network of an endobronchial tool training device. The method may comprise providing at least one simulated abnormality within a body of simulated lung tissue, and providing a simulated human lung branch airway network within the body of simulated lung tissue to be coupled with the simulated human lung main airway network so that an endobronchial tool is steerable through the simulated human lung main airway network and into the simulated human lung branch airway network to a position adjacent the at least one simulated abnormality.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is perspective view of the endobronchial tool training device having a simulated human lung main airway network and at least one training cartridge removably coupled thereto according to an example embodiment of the disclosure.

FIG. 2 is a schematic view of the endobronchial tool training device of FIG. 1 showing different training cartridges having selectable rotational angles.

FIG. 3 is a perspective view of a molded training cartridge that may be used with the endobronchial tool training device of FIGS. 1 and 2.

FIG. 4 is a schematic view of a 3D printer used to 3D print a training cartridge and at least one simulated abnormality therein.

FIG. 4A is a schematic view of a 3D printer used to 3D print the simulated human lung main airway network.

FIG. 5 is another schematic illustration of the endobronchial tool training device showing a simulated human lung main blood vessel network.

FIG. 6 is a high-level flowchart showing a method for making the endobronchial tool training device.

FIG. 7 is a high-level flowchart showing a method for making a training cartridge.

FIG. 8 is an environmental view of a robotic bronchoscopy platform having an endobronchial tool that may be used with the endobronchial tool training device.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

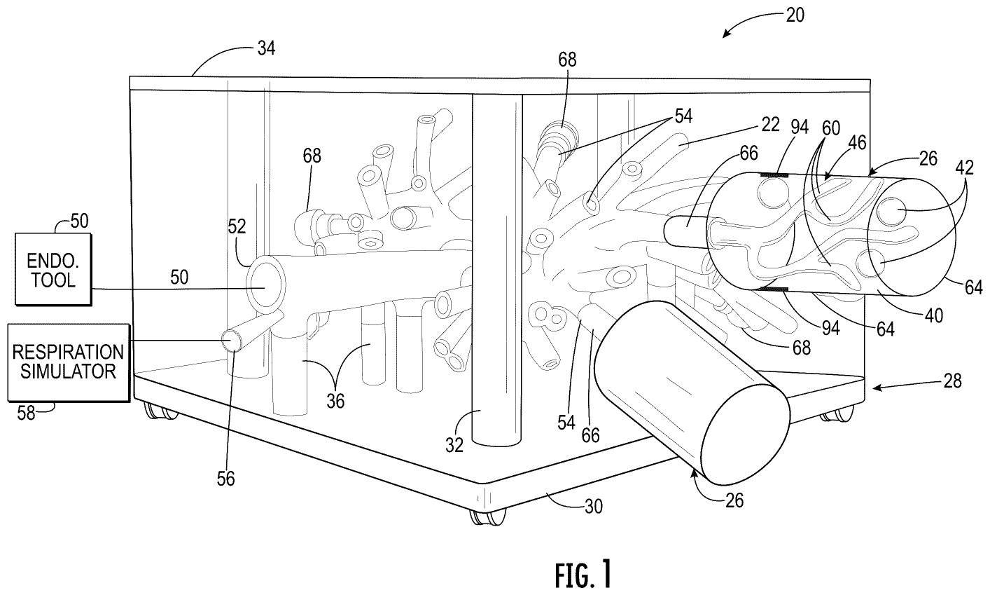

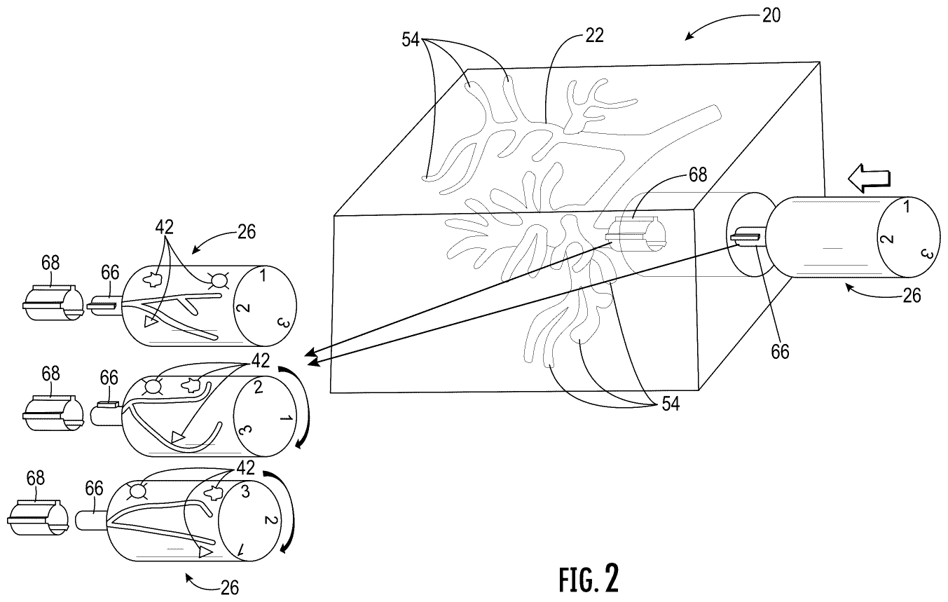

Referring now to FIGS. 1 and 2, an endobronchial tool training device is illustrated generally at 20 and includes a simulated human lung main airway network 22 and at least one training cartridge 26 removably coupled to the simulated human lung main airway network. In the example of FIG. 1, a training device frame 28 supports the simulated human lung main airway network 22 and any training cartridges 26, and may be formed from a base 30 having vertical supports 32 and clear top platform 34 such as plexiglass so that an observer looking down through the clear top platform may view any endobronchial tool training. The simulated human lung main airway network 22 and training cartridges 26 may be supported on airway supports 36.

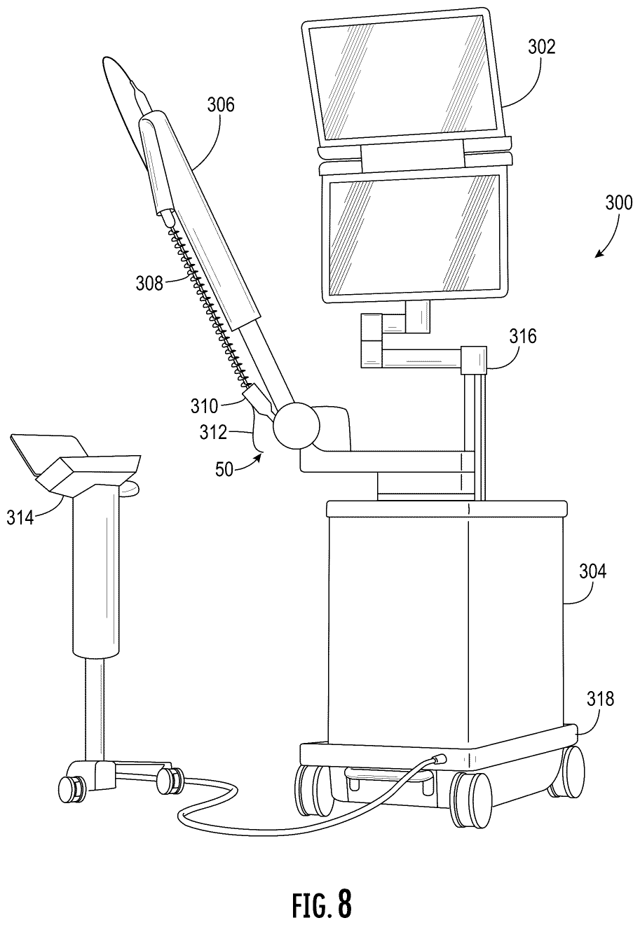

The at least one training cartridge 26 may be formed from a body of simulated lung tissue 40 having at least one simulated abnormality 42 within the body of simulated lung tissue. A simulated human lung branch airway network 46 may be within the body of simulated lung tissue 40 and coupled with the simulated human lung main airway network 22 so that an endobronchial tool 50 as shown in FIG. 8 and described in detail below may be steerable through the simulated human main airway network 22 and into the simulated human lung branch airway network 46 to a position adjacent the at least one simulated abnormality 42.

The simulated human lung main airway network 22 has a first proximal opening 52 to receive the endobronchial tool 50 therein and at least one distal opening 54 coupled to the at least one training cartridge 26. In an example, the simulated human lung main airway network 22 has a second proximal opening 56 for receiving a respiration simulator 58 for delivering air to the simulated human lung main airway network 22 and the simulated human lung branch airway network 46 of each training cartridge 26 to simulate human respiration. The first proximal opening 52 may receive the endobronchial tool 50 and the second proximal opening 56 may receive the respiration simulator 58. It is also possible that only one proximal opening may be formed to receive both the endobronchial tool 50 and respiration simulator 58 or one proximal opening split into separate channels, i.e., one for air flow and the other for the endobronchial tool 50.

As shown in the example of the training cartridge 26 in the upper right of FIG. 1, the simulated human lung branch airway network 46 is formed with interconnected branches 60 and at least one simulated abnormality 42 between adjacent branches. Each of the training cartridges 26 may include a housing 64 surrounding the body of simulated lung tissue 40. Each housing 64 may include a cartridge connector 66 that is configured to couple the training cartridge to the simulated human lung main airway network 22, which may include connector fittings 68 positioned at different distal openings 54 as shown in FIG. 1.

The housing 64 and adjacent portions of the simulated human lung main airway network 22 may define a plurality of selectable rotational coupling angles therebetween such as shown in the three examples of the training cartridges in FIG. 2, where the different rotational coupling angles are numbered 1, 2 and 3. This plurality of selectable rotational angles, e.g., 1, 2 and 3, may define respective different abnormality positions as shown by the different positions of abnormalities 42 in each of the three training cartridges 26. An abnormality 42 may be formed of at least one simulated tumor that may be formed from hydrogel such as shown by the spherical simulated abnormalities in the training cartridge 26 located in the upper right of the training device 20 FIG. 1. The simulated tumor 42 may also be referred to as a pseudotumor and may be formed by using a premixed sodium alginate mixture having added coloring agent, such as neon paint, and a contrast agent, such as Omnipaque, that are mixed. A cross-linker, such as calcium chloride, is added to the mixture to begin congealing and clumping and then mixed to form an even mixture. Green color can be added such as spinach powder. In an example, about 20 millimeters of the completed mixture may be added into a syringe and the mixture as the pseudotumor hydrogel material injected, i.e., extruded, from the syringe into the area of the simulated human lung main airway network 22 or other parts of an open network in a matrix material forming the simulated human lung main airway network. It may also be injected within a training cartridge 26. The body of the simulated lung tissue 40 for each training cartridge 26 may also be formed from hydrogel.

Each of the training cartridges 26, such as the three training cartridges shown in FIG. 2, may provide for different training cartridges for respective different training scenarios. For example, each of the different training cartridges 26 may have a different simulated abnormality 42 that may be one of a different tumor type, size, shape, and location as shown by the different configurations of the abnormalities in the three illustrated training cartridges. Also, each of the different training cartridges 26 may have a different simulated human lung branch airway network 46 as shown by the different branched airway network configurations for the interconnected branches 60 of the three training cartridges. Although the endobronchial tool training device 20 of FIG. 1 shows only two training cartridges 26 coupled to the simulated human lung main airway network 22, a greater number of training cartridges may be connected at different respective locations, for example, to each of the connector fittings 68. Because the training cartridge 26 may be coupled to the simulated human lung main airway network 22 at different respective rotational orientations, even if each training cartridge has similarly configured interconnected branches 60 and positions of abnormalities 42 relative to the branches, the different orientations will change the orientation and position of the abnormalities and interconnected branches relative to the human lung main airway network 22 and provide a different training scenario.

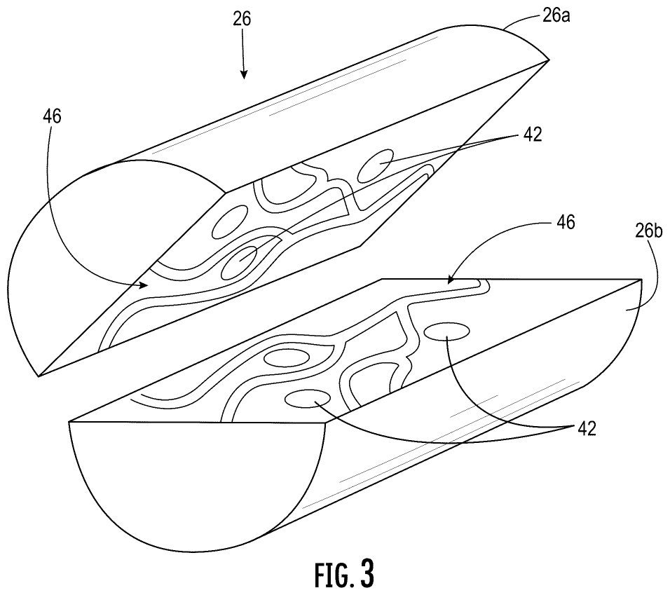

As shown in FIG. 3, the training cartridge 26 may be formed from two molded halves 26a, 26b with the at least one simulated abnormality 42 such as a tumor being a preformed simulated tumor molded into the body of the simulated lung tissue 40. In this example, the human lung branch airway network 46 may be formed in the two halves 26a, 26b together with the abnormalities 42 as simulated tumors, e.g., from hydrogel, and placed together and inserted into a housing 64 to form the training cartridge 26. The simulated abnormality 42 as a tumor may also be at least one preformed simulated tumor injected into the body of the simulated lung tissue 40, and also formed from hydrogel that allows injection during the molding process.

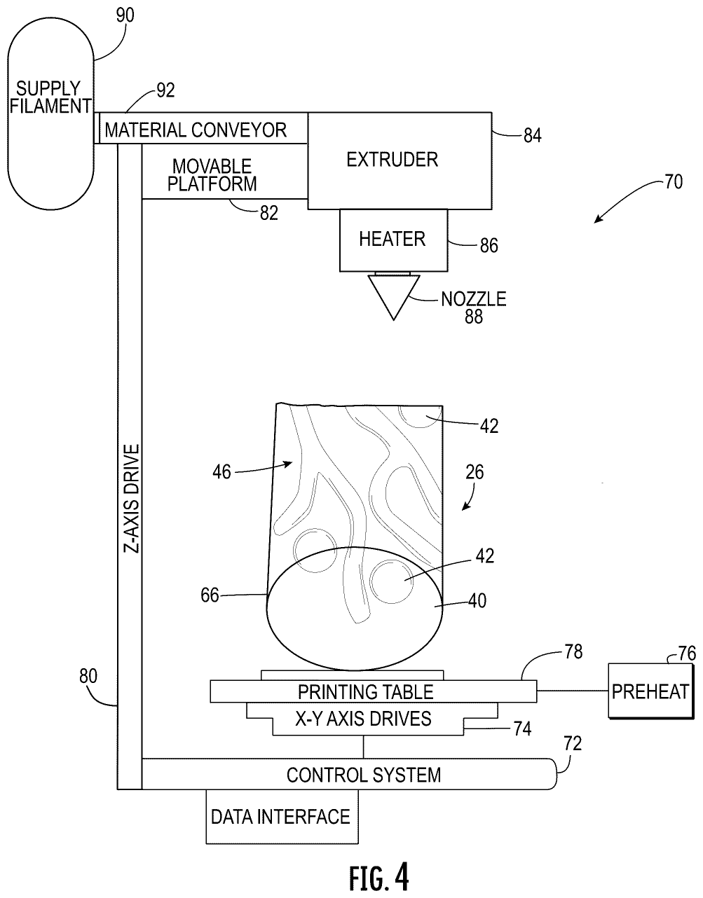

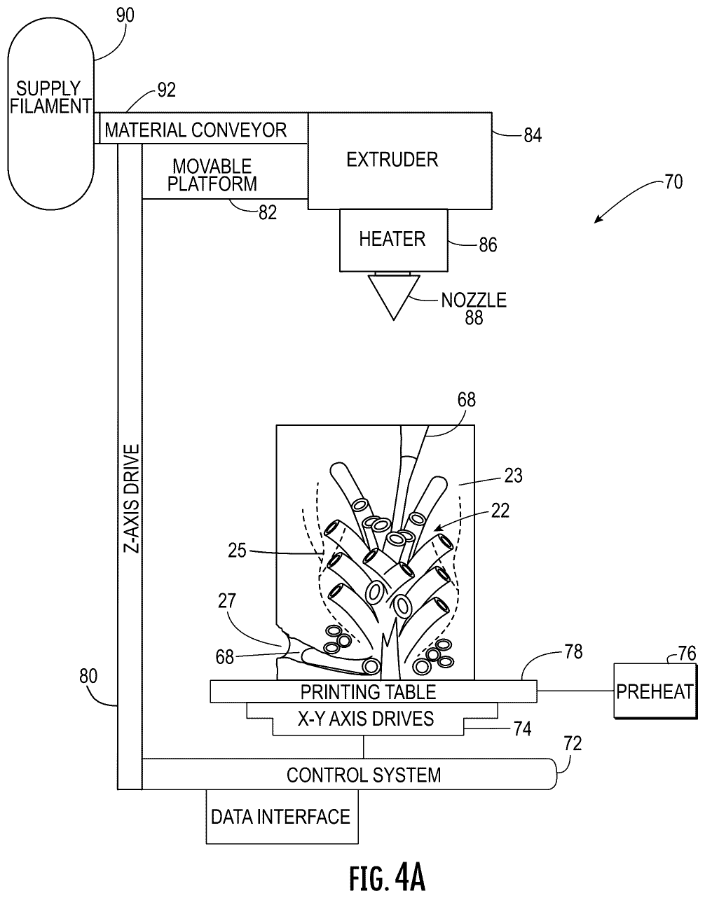

As shown in the schematic diagram of FIG. 4 illustrating a 3D printer 70, it is possible that the entire training cartridge 26 may be 3D printed so that the body of simulated lung tissue 40, at least one simulated abnormality 42, the simulated human lung branch airway network 46, and even the housing 64 may be 3D printed on the 3D printer. The body of simulated lung tissue 40, simulated abnormality 42 as the example tumor, the simulated human lung branch airway network 46 and housing 64 are 3D printed concurrently with each other. Different 3D printers 70 may be used. The example 3D printer 70 shown in FIG. 4 includes a control system 72, X-axis and Y-axis drives 74, preheat system 76 for a printing table 78, a Z-axis drive 80 connected to a movable platform 82 securing an extruder 84 and heater 86 for a nozzle head 88. A material filament source 90 supplies material for 3-D printing that is fed via a material conveyor 92 to the extruder 84, heater 86 and nozzle head 88 to form the 3D printed product as the training cartridge 26.

A partially printed training cartridge 26 is shown in the schematic diagram of FIG. 4. It is also possible to 3D print the simulated human lung main airway network 22, which may include abnormalities 42 printed therein. Because modern 3D printers include support for feeding different materials and different types and diameters of filaments, it is possible that the simulated tumor as an abnormality 42 may be formed from a different material as the body of simulated lung tissue 40 and other portions. 3D printing is advantageous since the simulated human lung main airway network 22 may include a plurality of interconnected tubes, giving accuracy to the location of the different tubes simulating the human lung main airway network so that the simulated human lung main airway network and training cartridges 26 may be previously formed using actual CT scans of the lungs from a specific patient.

Referring now to FIG. 4A, the 3D printer 70 is used to print a simulated human lung main airway network 22 such as by printing an open network in a matrix material 23 as illustrated. The matrix material 23 may include a separate perfusion network as shown by the dashed lines at 25, and may have cutouts 27, such as cylindrical cutouts, that allow training cartridges 26 to be inserted and replaced. The “rotational coupling” features as part of the connection fittings 68 may be printed as well in the matrix material 23 as an alternative as having them on the training cartridge 26. Because the 3D printer is controlled by a control system 72 that can be programmed to print the simulated human lung main airway network 22, the specific supply filaments and feed rates may be established for printing that component. The structural components for the 3D printer 70 illustrated in FIG. 4 are the same as the structural components illustrated in FIG. 4A to give the same reference numerals, since the only changes may be in the specific programming in the control system 72 and the supply filaments from the material filament source 90 and heating parameters of the heater 86 and the preheat system 76.

A training cartridge 26 may also include a temperature sensitive element 94 associated therewith (FIG. 1) so that during the endobronchial tool training any type of heat applied, e.g., for cautery, biopsy or ablation, the temperature sensitive element may indicate the location where that heat has been applied. For example, the temperature sensitive element 94 may be positioned within the body of simulated lung tissue 40 and may even be formed as a temperature sensor that can register the exact temperature applied during training. The temperature sensitive element 94 may also be a thermochromic material, for example, forming part of the simulated lung tissue 40 or abnormality 42.

It is also possible that the simulated human lung main airway network 22 and at least one training cartridge 26 may be formed from respective materials that are compatible with medical imaging so that portions are visible. As an example, at least one simulated abnormality 42 and the simulated human lung main airway network 22 and simulated human lung branch airway network 46 may be visible on system monitors, for example, for CT scanning monitors or other type of monitor scanning. The at least one training cartridge 26 may also be formed of a material that is at least one of imaging-abled as described before, but also self-healing, ablation-responsive, such as using the temperature sensitive element 94, and electrocautery-responsive such as a gel that is responsive to electrocautery.

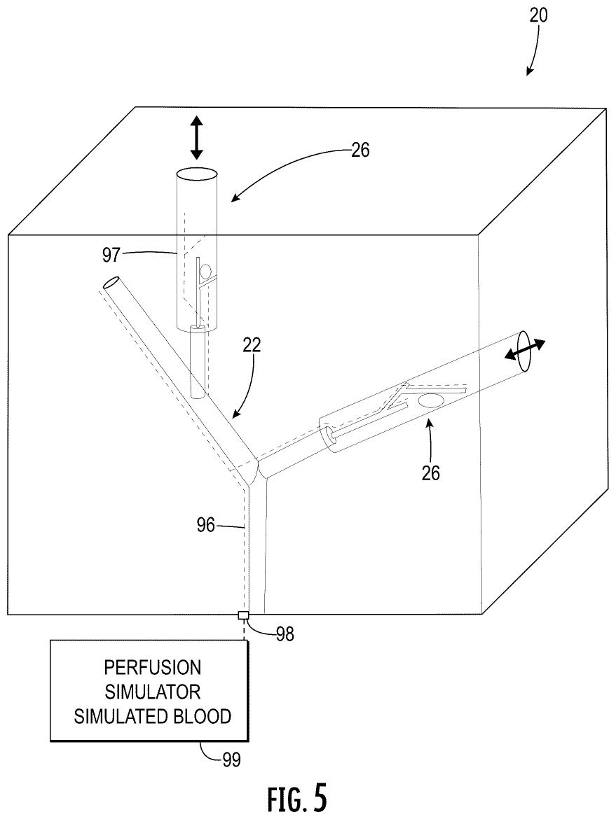

Referring now to the schematic diagram of the endobronchial tool training device 20 in FIG. 5, a simulated human lung main blood vessel network 96 is shown by the dashed lines extending adjacent the human lung main airway network 22 and branching off therefrom. Schematic diagrams of two training cartridges 26 are shown removably coupled to the simulated human lung main airway network 22 with each training cartridge also including a simulated human lung branch blood vessel network 97. The simulated human lung made blood vessel network 96 includes a proximal opening 98 for receiving a perfusion simulator 99 and delivering simulated blood to the simulated human lung main blood vessel network 96 and the simulated human lung branch blood vessel network 97. Simulated blood may be formed from different materials such as described in U.S. Pat. No. 11,682,319, assigned to Intuitive Surgical Operations, Inc., the disclosure which is hereby incorporated by reference in its entirety.

The simulated human lung main airway network 22 has a proximal opening 52 similar to that of FIG. 1 that may receive not only the endobronchial tool 50, but also the respiration simulator 58 for delivering a simulated airflow such as for simulated lung expansion and contraction. Additionally, two openings could be defined, i.e., one for the endobronchial tool 50 and the other for the respiration simulator 58 as shown in FIG. 1.

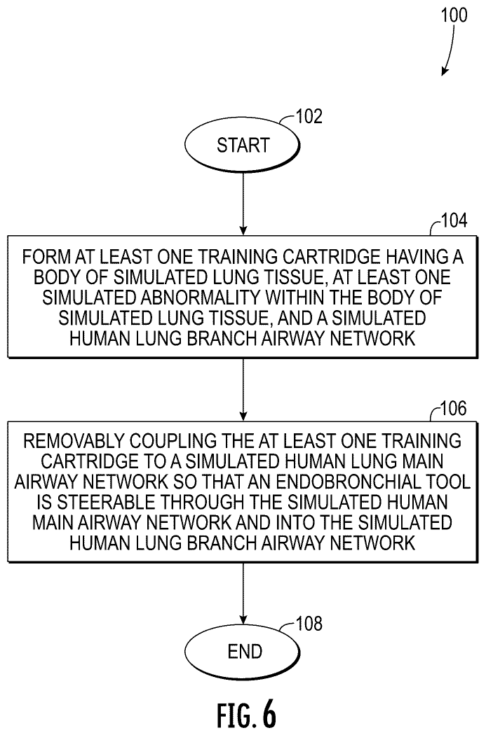

Referring now to FIG. 6, a high-level flowchart of a method of making an endobronchial tool training device 20 is illustrated generally at 100. The method starts (Block 102) by forming the training cartridge 26 with a body of simulated lung tissue 40, at least one simulated abnormality 42 within the body of simulated lung tissue and a simulated human lung branch airway network 42 within the body of simulated lung tissue (Block 104). The at least one training cartridge 26 is removably coupled to the simulated human lung main airway network 22 so that an endobronchial tool 50 is steerable through the simulated human lung main airway network and into the simulated human lung branch airway network 46 to a position adjacent the at least one simulated abnormality 42 (Block 106). The process ends (Block 108).

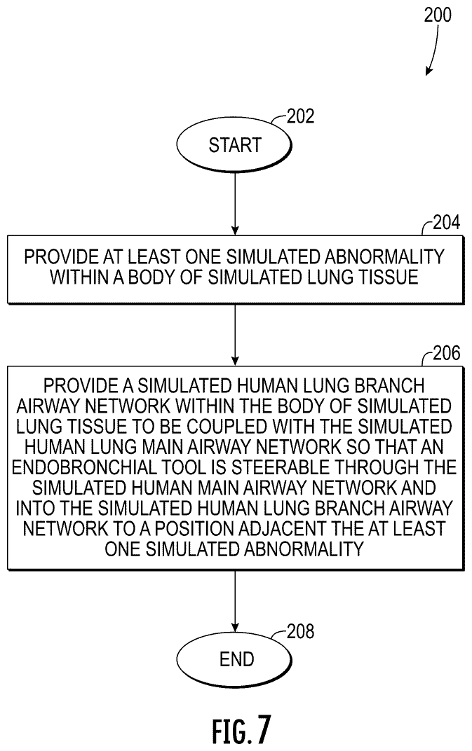

Referring now to FIG. 7, a high-level flowchart of a method for making a training cartridge 26 to be removably coupled to a simulated human lung main airway network 22 of an endobronchial tool training device 20 is illustrated generally at 200. The method starts (Block 202) by providing at least one simulated abnormality 42 with the body of simulated lung tissue 40 (Block 204). A simulated human lung branch airway network 46 is provided within the body of the simulated lung tissue 40 to be coupled with the simulated human lung main airway network 22 so that an endobronchial tool 50 is steerable through the simulated human lung main airway network 22 and into the simulated human lung branch airway network 46 to a position adjacent the at least one simulated abnormality 42 (Block 206). The process ends (Block 208).

Another technique for making the simulated human lung main airway network 22, simulated tumors 42 and the matrix material 23 as the lung-like material is to have a mold, e. g., similar to a paper cup, with the human lung main airway network and simulated tumors placed in it (they may be 3D printed). The matrix material 23 as the lung-like material is poured into it. This matrix material 23 may be a formulation of liquid polyvinyl chloride or similar material that would allow visualization of the human lung main airway network 22 and simulated tumors 42 under CT scan and possibly fluoroscopy. A simulated tumor 42 itself would be made of a different formulation (possibly of formed liquid PVC) so that it met the requirements of being visible on CT scan, visible on radial ultrasound, fluorescent under UV or black light, and yield a specimen from a brush biopsy, cup biopsy, and needle aspiration. A second tube or opening on the simulated human lung main airway network 22 may not be required for ventilation, but it may be helpful as a technique to introduce motion.

The endobronchial tool training device 20 may demonstrate discordance between a treatment plan and reality at the time of the training procedure. This occurs clinically and can be adjusted by the operator using software that controls any machine that operates the endobronchial tool 50 to train. This discordance may be achieved by just rotating the training cartridge 26 a very small amount from where it was during the planning CT stage, or having a second set of training cartridges which introduce the desired discordance.

Referring now to FIG. 8, there is illustrated a robotic bronchoscopy platform 300 that may be used with the endobronchial tool training device 20 described above. The example robotic bronchoscopy platform 300 includes an endobronchial tool 50 that is steerable through the simulated human main airway network 22 and into a simulated human lung branch airway network 46 as part of a training cartridge 26 may be the robotic bronchoscopy platform manufactured by Intuitive Surgical, Operations, Inc. of Sunnyvale, California, under the platform name ION.

The illustrated robotic bronchoscopy platform 300 includes system monitors 302 that are connected to a system cart 304 that includes a flexible instrument arm 306 that may be robotically controlled. The flexible instrument arm 306 includes a catheter guide 308, a swivel connector 310, and fully articulating catheter 312. The robotic platform 300 may be controlled by a controller 314. A movable support arm 316 supports the system monitors 302 for monitoring the training session. The system cart 304 and controller 314 are movable on a wheel platform 318 to facilitate positioning the platform 300 in the desired location for training or real-life surgery.

The endobronchial tool training device 20 may be used to train surgeons to collect lung tissue samples for biopsy, even when lung nodules are small and located in the peripheral sections of the lung. The ultrathin, ultra-maneuverable catheter allows a student or surgeon to reach small lesions in all 18 segments of the lung with reach, precision, and stability.

It is possible to navigate to an abnormality 42 along a pre-planned path using the robotic catheter because it has advanced maneuverability. In an example, the catheter has about a 3.5 millimeter outer diameter and a 2.0 millimeter working channel that can articulate under 180° in any direction and pass around tight turns allowing it to reach all 18 segments of the lung. A camera may provide a 120° field of view and sharp videoscopic images may be viewed on the system monitors 302. The catheter may be locked in place, and includes a shape sensor real-time measurement capability and robotic control algorithms that allow the catheter to hold its position. A flexible needle may be custom-designed to pass through the catheter even when positioned in tortuous airways.

This description and the accompanying drawings that illustrate various embodiments should not be taken as limiting. Various mechanical, compositional, structural, electrical, and operational changes may be made without departing from the scope of this description and the invention as claimed, including equivalents. In some instances, well-known structures and techniques have not been shown or described in detail so as not to obscure the disclosure. Like numbers in two or more figures represent the same or similar elements. Furthermore, elements and their associated features that are described in detail with reference to one embodiment may, whenever practical, be included in other embodiments in which they are not specifically shown or described. For example, if an element is described in detail with reference to one embodiment and is not described with reference to another embodiment, the element may nevertheless be claimed as included in the other embodiment.

For the purposes of this specification and appended claims, unless otherwise indicated, all numbers expressing quantities, percentages, or proportions, and other numerical values used in the specification and claims, are to be understood as being modified in all instances by the term “about,” to the extent they are not already so modified. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the invention. For example, spatially relative terms-such as “beneath”, “below”, “lower”, “above”, “upper”, “proximal”, “distal”, and the like-may be used to describe one element's or feature's relationship to another element or feature as illustrated in the figures. These spatially relative terms are intended to encompass different positions (i.e., locations) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the example term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various embodiments shown and described herein are to be taken as examples. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the spirit and scope of the present teachings and following claims.

It is to be understood that the particular examples and embodiments set forth herein are non-limiting, and modifications to structure, dimensions, materials, and methodologies may be made without departing from the scope of the present teachings.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. An endobronchial tool training device comprising:
a simulated human lung main airway network; and
at least one training cartridge removably coupled to the simulated human lung main airway network and comprising
a body of simulated lung tissue,
at least one simulated abnormality within the body of simulated lung tissue, and
a simulated human lung branch airway network within the body of simulated lung tissue and coupled with the simulated human lung main airway network so that an endobronchial tool is steerable through the simulated human lung main airway network and into the simulated human lung branch airway network to a position adjacent the at least one simulated abnormality.

2. The endobronchial tool training device of claim 1, wherein the simulated human lung main airway network has a proximal opening to receive the endobronchial tool therein and at least one distal opening coupled to the at least one training cartridge.

3. The endobronchial tool training device of claim 1, wherein the simulated human lung branch airway network comprises interconnected branches; and wherein the at least one simulated abnormality is between adjacent branches.

4. The endobronchial tool training device of claim 1, wherein the simulated human lung main airway network and at least one training cartridge each comprises respective materials compatible with medical imaging so that the at least one simulated abnormality is visible.

5. The endobronchial tool training device of claim 1, wherein the at least one training cartridge comprises a housing surrounding the body of simulated lung tissue.

6. The endobronchial tool training device of claim 5, wherein the housing and adjacent portions of the simulated human lung main airway network define a plurality of selectable rotational coupling angles therebetween.

7. The endobronchial tool training device of claim 1, wherein the at least one simulated abnormality comprises at least one simulated tumor.

8. The endobronchial tool training device of claim 7, wherein the at least one simulated tumor comprises a hydrogel.

9. The endobronchial tool training device of claim 7, wherein the at least one simulated tumor comprises at least one preformed simulated tumor injected into the body of simulated lung tissue.

10. The endobronchial tool training device of claim 7, wherein the at least one simulated tumor comprises at least one preformed simulated tumor molded into the body of simulated lung tissue.

11. The endobronchial tool training device of claim 1, wherein the at least one training cartridge comprises a temperature sensitive element associated therewith.

12. The endobronchial tool training device of claim 11, wherein the temperature sensitive element is positioned within the body of simulated lung tissue.

13. The endobronchial tool training device of claim 11, wherein the temperature sensitive element comprises a temperature sensor.

14. The endobronchial tool training device of claim 11, wherein the temperature sensitive element comprises a thermochromic material.

15. The endobronchial tool training device of claim 1, wherein the body of simulated lung tissue comprises hydrogel.

16. The endobronchial tool training device of claim 1, wherein the simulated human lung main airway network comprises a plurality of interconnected tubes.

17. The endobronchial tool training device of claim 1, wherein the simulated human lung main airway network has a proximal opening for receiving a respiration simulator for delivering air to the simulated human lung main airway network and the simulated human lung branch airway network.

18. The endobronchial tool training device of claim 1, further comprising a simulated human lung main blood vessel network.

19. The endobronchial tool training device of claim 1, wherein the at least one training cartridge comprises a plurality of different training cartridges for respective different training scenarios.

20. The endobronchial tool training device of claim 19, wherein each of the plurality of different training cartridges has a different simulated abnormality.

21. The endobronchial tool training device of claim 19, wherein the different simulated abnormality comprises at least one of a different tumor type, size, shape and location.

22. The endobronchial tool training device of claim 1, wherein the at least one training cartridge comprises a plurality of training cartridges coupled to the simulated human lung main airway network at different respective locations.

23. The endobronchial tool training device of claim 1, wherein the at least one training cartridge comprises a plurality of training cartridges coupled to the simulated human lung main airway network with different respective rotational orientations.

24. The endobronchial tool training device of claim 1, wherein the at least one training cartridge comprises a material being at least one of imaging-abled, self-healing, ablation-responsive, and electrocautery-responsive.

25. A method for making an endobronchial tool training device, the method comprising:
removably coupling at least one training cartridge to a simulated human lung main airway network, the at least one training cartridge comprising
a body of simulated lung tissue,
at least one simulated abnormality within the body of simulated lung tissue, and
a simulated human lung branch airway network within the body of simulated lung tissue and coupled with the simulated human lung main airway network so that an endobronchial tool is steerable through the simulated human lung main airway network and into the simulated human lung branch airway network to a position adjacent the at least one simulated abnormality.
